(19) United States
(12) Patent Application Publication
(10) Pub. No.: US 2025/0360449 A1
(43) Pub. Date: Nov. 27, 2025

(54) Scrubber Device for Scrubbing Hydrocarbon Gas Stream Including Modified Sparger Ducts

(71) Applicant: 2376016 Alberta Inc., Neilburg (CA)

(72) Inventor: Lester Thiessen, Neilburg (CA)

(21) Appl. No.: 19/215,694

(22) Filed: May 22, 2025

Related U.S. Application Data
(60) Provisional application No. 63/650,695, filed on May 22, 2024.

(51) Int. Cl. B01D 47/10

(52) U.S. Cl. CPC B01D 47/10; B01D 2257/702; B01D 2321/30

(57) ABSTRACT

A gas scrubber device includes a liquid collection tank for separating a gas stream from produced hydrocarbon fluids and a scrubber for scrubbing a waste gas from the gas stream. The gas stream exits the tank into a manifold connected to sparger ducts having discharge openings below an operating level of scrubbing solution in the scrubber in which the sparger ducts and the manifold a situated at least partly above the operating level to define a head space along a length of the duct where gas pressure is balanced along the length of the sparger duct to discharge gas into the scrubbing solution more evenly. A drain line between the scrubbing chamber and the liquid collection tank allows the scrubbing solution to be periodically drained into the tank with the collected liquids when the line is selectively opened.

This application claims the benefit under 35 U.S.C. 119(e) of U.S. provisional application Ser. No. 63/650,695, filed May 22, 2024.

### FIELD OF THE INVENTION

The present invention relates to a scrubber device for passing a gas stream through a liquid scrubbing solution to remove a waste gas from the gas stream, and more particularly the present invention relates to a scrubber device for scrubber a waste gas, for example hydrogen sulfide, from a gas stream derived from produced hydrocarbons.

### BACKGROUND

In the production of hydrocarbons from a well, the produced fluids commonly include a mixture of water, oil and various gasses. Subsequent oil refining processes performed on the produced fluids commonly produce a gas stream that includes various toxic waste gases, for example hydrogen sulfide. Various scrubbing technologies exist to assist in removing toxic waste gases from the gas stream, for example by bringing the gas stream into contact with liquid or dry chemicals. Dry systems are hard to clean out and are dangerous due to the buildup of absorbed gases in the dry pellets.

In a liquid scrubbing system, the gas stream is typically discharged from a sparger pipe supported to span a length of the scrubbing chamber while being submerged within a scrubbing solution in the scrubbing chamber. The head pressure of the liquid in some instances can cause too much back pressure on the gas stream being discharged from the sparger pipe such that the gases are primarily discharged in high volumes from the inlet end of the sparger pipe where pressure is greatest so that some of the gases escape the depth of the scrubbing solution before reaching the end of the sparger pipe, which in higher flow situations would still reach the atmosphere without being absorbed by the scrubber solution.

### SUMMARY OF THE INVENTION

According to one aspect of the invention there is provided a gas scrubber device for scrubbing a waste gas from a gas stream using a scrubbing solution, the device comprising:
(i) a scrubbing chamber arranged to contain an operating level of the scrubbing solution therein;
(ii) a manifold having a gas inlet arranged to receive the gas stream into the manifold;
(iii) at least one sparger duct supported within the scrubbing chamber to extend longitudinally between two opposing ends of the sparger duct, in which the at least one sparger duct is in communication with the manifold to receive the gas stream from the manifold, and in which the sparger duct includes a plurality of discharge openings formed therein below the operating level of the scrubbing solution so as to be arranged to discharge the gas stream into the scrubbing solution in the scrubbing chamber; and
(iv) a discharge passage in communication with the scrubbing chamber above the operating level of the scrubbing solution so as to be arranged to discharge the gas stream from the scrubbing chamber subsequent to the gas stream passing through the scrubbing solution;
(v) wherein the at least one sparger duct is supported within the scrubbing chamber so as to be only partially submerged relative to the operating level of the scrubbing solution whereby a head space is defined within the sparger duct above the operating level of the scrubbing solution, the head space extending in open communication between the ends of the sparger duct.

The use of a head space spanning a length of each sparger duct above the operating level of scrubbing solution ensures that the gasses to be scrubbed readily flow along the full length of the sparger duct so that gas pressure is balanced along the length of the sparger duct. The balanced pressure along the length of the sparger duct provides a more even discharge of the gas through the discharge openings along the length of the sparger duct so as to prevent excess flow of gas being discharged through the discharge openings that are nearest to the manifold. The even distribution of the gas being discharged into the scrubbing solution results in a more effective scrubbing of the waste gases from the gas stream.

When the scrubbing chamber is elongated in a longitudinal direction extending between the ends of the scrubbing chamber, said at least one sparger duct preferably extends from the manifold in said longitudinal direction of the tank.

Preferably said at least one sparger duct comprises a plurality of sparger ducts extending longitudinally between the ends of the duct, in which the sparger ducts may be parallel and laterally spaced apart from one another.

The manifold may be supported at one end of the scrubbing chamber above the operating level of the scrubbing solution. In this instance, said at least one sparger duct may span a majority of a length of the scrubbing chamber from the manifold at the end of the scrubbing chamber.

Each sparger duct preferably locates the discharge openings primarily in laterally opposing side walls of the sparger duct in which the side walls have a height between top and bottom ends of the sparger duct which is at least two times greater than a width of the sparger duct between the side walls of the sparger duct.

Each sparger duct preferably communicates with the manifold at a location spaced above the operating level of the scrubbing solution, for example at a top end of the sparger duct.

The discharge openings in the sparger duct are preferably situated adjacent a bottom of the sparger duct.

Each sparger duct is preferably located directly adjacent a bottom of the sparger duct.

The manifold is preferably located fully above the operative level of the scrubbing solution.

The device may further include at least one baffle supported in the scrubbing chamber alongside said at least one sparger duct so as to be arranged to limit turbulent flow of the scrubbing solution in response to the discharge of the gas stream into the scrubbing solution in the scrubbing chamber.

When multiple sparger ducts extend longitudinally between the ends of the duct so as to be spaced apart laterally from one another, said at least one baffle preferably includes an upright divider baffle supported at an intermediate location between an adjacent pair of the sparger ducts.

When multiple sparger ducts extending longitudinally between the ends of the duct so as to be spaced apart laterally from one another, and said at least one baffle preferably includes a plurality of sloped baffles, in which each sloped baffle is in operative relation with the discharge openings along one side of a respective one of the sparger ducts and is sloped upwardly and inwardly towards the respective sparger duct to terminate at an upper edge of the sloped baffle that is spaced above the discharge openings and spaced outward from the side of the respective sparger duct.

In some embodiments, the device may further include a gas separator for separating produced hydrocarbon fluids into collected liquids and said gas stream directed into the gas inlet of the manifold, the gas separator comprising: (a) a liquid collection tank arranged to collect a maximum level of the collected liquids therein; (b) a flow inlet coupled to the liquid collection tank at a level above the maximum level so as to be arranged to receive the produced hydrocarbon fluids into the liquid collection tank through the flow inlet for separation of the gas stream from the collected liquids in the liquid collection tank; (c) a gas passage coupled between (i) the liquid collection tank above the maximum level and (ii) the gas inlet of the manifold so as to be arranged to direct the gas stream from the gas separator to the gas inlet of the manifold; and (d) a drain line connected between the scrubbing chamber below the operating level of the scrubbing solution and the liquid collection tank, the drain line including a valve connected in line with the drain line to selectively open and close the drain line.

The device may further include a pressure discharge valve in operative connection with the liquid collection tank at a location above the maximum level so as to be arranged to controllably discharge pressure of the gas stream from the liquid collection tank when the pressure discharge valve is opened.

The pressure discharge valve may be in communication with the discharge passage of the scrubbing chamber such that the gas stream in the liquid collection tank is discharged to the discharge passage of the scrubbing chamber when the pressure discharge valve is opened.

According to a second aspect of the present invention there is provided a method of operating the gas scrubbing device comprising:
(i) providing the scrubbing solution in the scrubbing chamber at said operating level such that (a) said head space is defined within said at least one sparger duct above the operating level of the scrubbing solution, and (b) the discharge openings in said at least one sparger duct are spaced below the operating level; and
(ii) injecting the gas stream into the manifold such that the gas stream passes through the head space to the discharge openings in said at least one sparger for discharge through the discharge passage of the scrubbing chamber after the gas stream passes through the scrubbing solution.

According to a third aspect of the present invention there is provided a gas scrubber device for separating produced hydrocarbon fluids into collected liquids and a gas stream, and for scrubbing a waste gas from the gas stream using a scrubbing solution, the device comprising:
a scrubbing chamber arranged to contain an operating level of the scrubbing solution therein;
a manifold having a gas inlet arranged to receive the gas stream into the manifold;
at least one sparger duct supported within the scrubbing chamber in communication with the manifold to receive the gas stream from the manifold, in which the sparger duct includes a plurality of discharge openings formed therein below the operating level of the scrubbing solution so as to be arranged to discharge the gas stream into the scrubbing solution in the scrubbing chamber;
a discharge passage in communication with the scrubbing chamber above the operating level of the scrubbing solution so as to be arranged to discharge the gas stream from the scrubbing chamber subsequent to the gas stream passing through the scrubbing solution;
a liquid collection tank arranged to collect a maximum level of the collected liquids therein;
a flow inlet coupled to the liquid collection tank at a level above the maximum level so as to be arranged to receive the produced hydrocarbon fluids into the liquid collection tank through the flow inlet for separation of the gas stream from the collected liquids in the liquid collection tank;
a gas passage coupled between (i) the liquid collection tank above the maximum level and (ii) the gas inlet of the manifold so as to be arranged to direct the gas stream from the gas separator to the gas inlet of the manifold; and
a drain line connected between the scrubbing chamber below the operating level of the scrubbing solution and the liquid collection tank, the drain line including a valve connected in line with the drain line to selectively open and close the drain line.

### BRIEF DESCRIPTION OF THE DRAWINGS

One embodiment of the invention will now be described in conjunction with the accompanying drawings in which:

FIG. 1 is a schematic perspective view of a scrubber portion of the gas scrubber device, shown separated from a gas separator of the gas scrubber device;

FIG. 2 is a partly sectional side elevational view of the scrubber portion of the gas scrubber device according to FIG. 1;

FIG. 3 is a partly sectional top view of the scrubber portion of the gas scrubber device according to FIG. 1;

FIG. 4 is a perspective view of one of the sparger ducts shown removed from the scrubbing chamber of the scrubber portion of the gas scrubber device;

FIG. 5 is a sectional view along the line 5-5 in FIG. 2;

FIG. 6 is a sectional view along the line 6-6 in FIG. 2;

FIG. 7 is a side view of the gas scrubber device including the gas separator and the scrubber portion of FIG. 1 shown mounted on the gas separator;

FIG. 8 is a top view of the gas scrubber device including the gas separator and the scrubber portion of FIG. 1 shown mounted on the gas separator; and

FIG. 9 is an enlarged end view of one of the baffle arrangements received between the sparger ducts in the scrubber portion of the gas scrubber device according to FIG. 1.

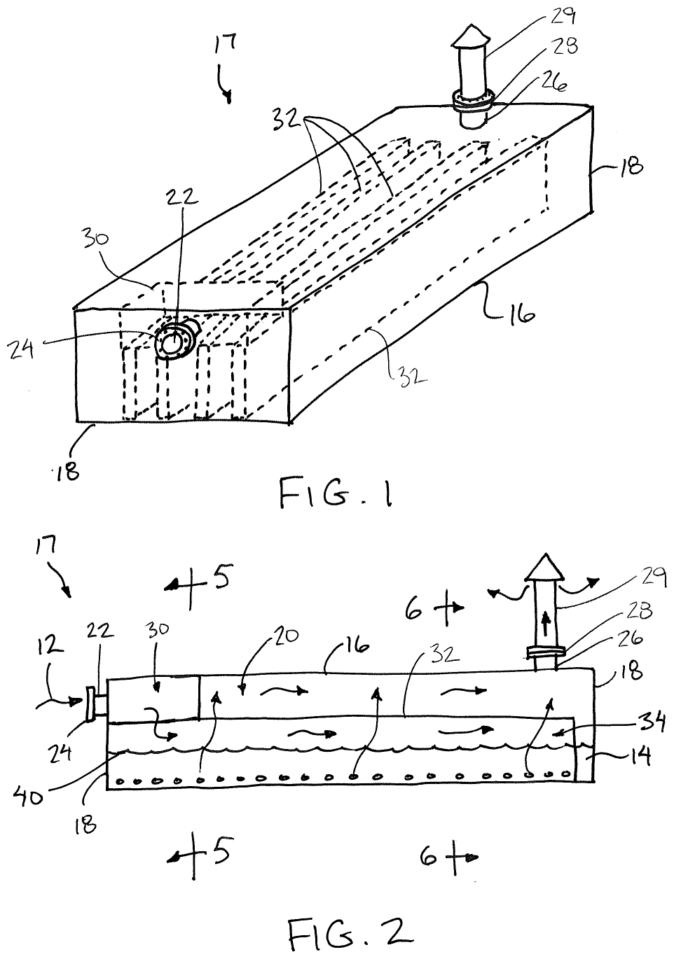

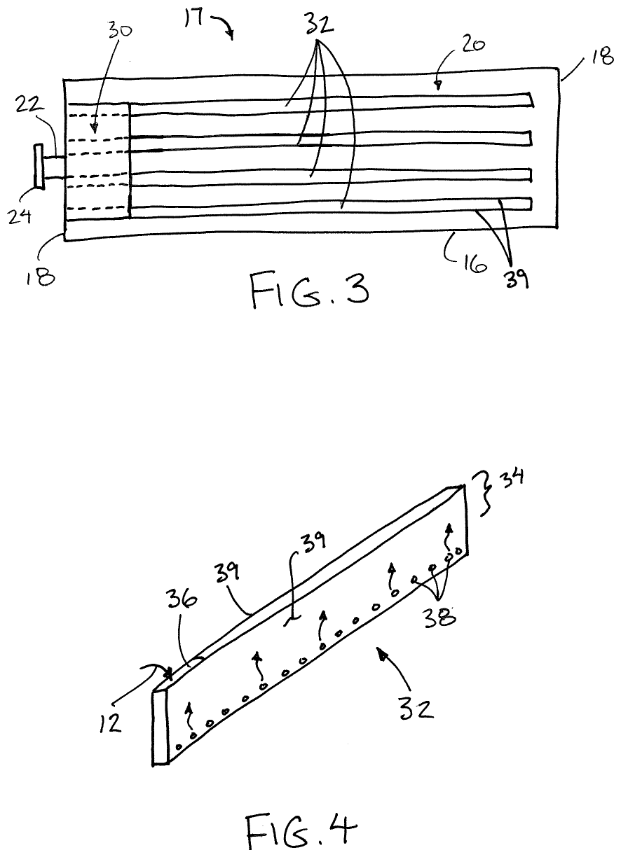

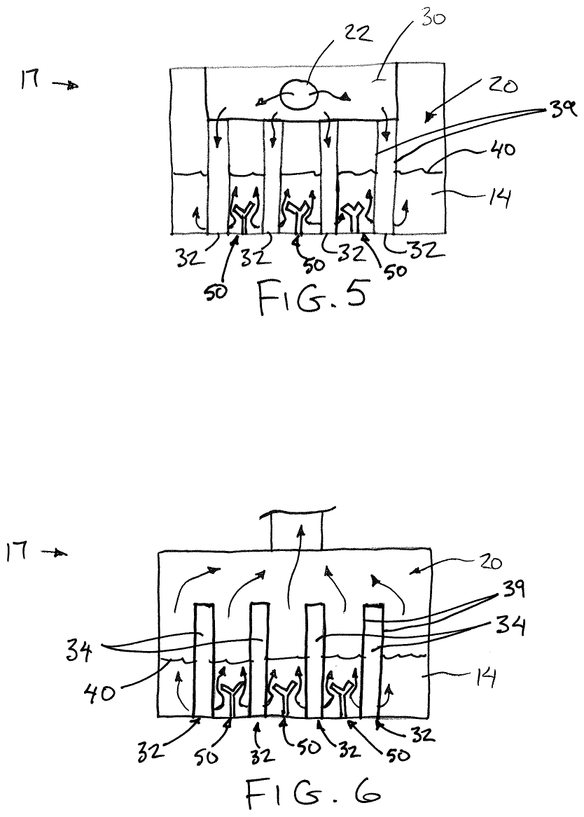

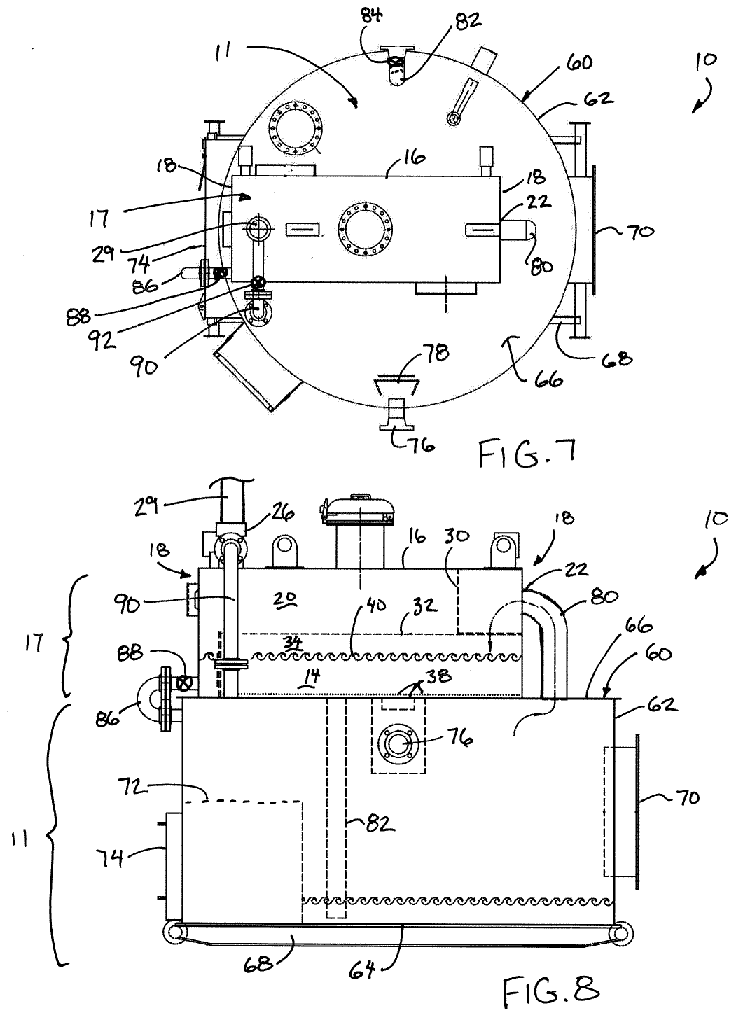

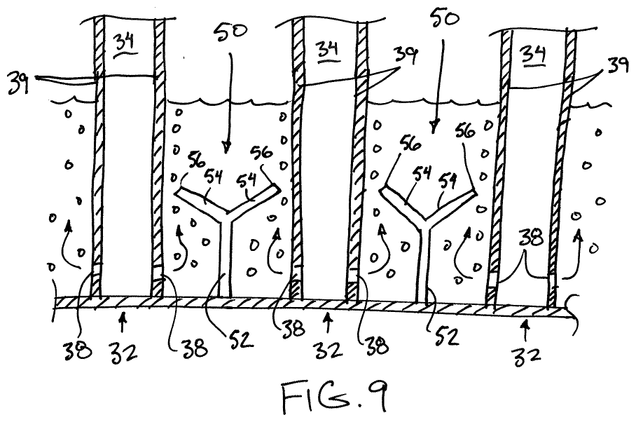

In the drawings like characters of reference indicate corresponding parts in the different figures.

### DETAILED DESCRIPTION

Referring to the accompanying figures, there is illustrated a gas scrubber device generally indicated by reference numeral 10. The gas scrubber device 10 may including a gas separator 11 for separating produced hydrocarbon fluids into collected liquids 15 and a separated gas stream 12 and a scrubber 17 for scrubbing a waste gas from the gas stream 12 using a liquid scrubbing solution 14, for example scrubbing hydrogen sulfide from other gaseous products derived from produced hydrocarbon fluids from a wellbore.

The scrubber 17 is downstream from the gas separator 11 which separates the gas stream from the remaining oil and water in the produced hydrocarbon fluids to be captured as the collected fluids 15. Once separated, the gas stream 12 is directed into the scrubber 17 to pass through the scrubbing solution 14 before discharging the scrubbed gas stream to downstream equipment or to the atmosphere depending upon the application. The scrubber solution is a chemical solution arranged to capture hydrogen sulfide or other waste gases including toxic gases and the like.

The scrubber 17 includes a main scrubbing housing 16 which is generally rectangular in shape and which is elongated in a longitudinal direction extending between opposing ends 18 of the housing. The housing 16 defines external boundary walls surrounding and enclosing a scrubbing chamber 20 therein. The scrubbing chamber 20 is arranged for containing the liquid scrubbing solution 14 at the bottom of the chamber at a prescribed operating level above the floor of the chamber while containing gas within the chamber in an upper portion of the chamber occupying the space above the scrubbing solution.

A gas inlet pipe 22 communicates through the end wall of the housing at a first end to define a gas inlet passage extending therethrough which receives the gas stream to be scrubbed therein. The gas inlet pipe includes a pipe flange 24 at the outer end thereof for connection to upstream equipment which directs the gas stream into the device 10.

Similarly, a gas outlet pipe 26 communicates through the top wall of the housing adjacent a second end of the device opposite from the gas inlet pipe 24 to define a gas discharge passage extending therethrough from which the gas stream is discharged after scrubbing through the scrubbing chamber. The gas discharge passage is in open communication with the scrubbing chamber 20 within the main housing 16. The gas outlet pipe 26 includes a pipe flange 28 at the outer end thereof for connection to downstream equipment to which the gas stream is discharged after scrubbing through the device 10. In the illustrated embodiment, an exhaust stack 29 is connected to the pipe flange 28 for exhausting the scrubbed gas stream to atmosphere.

A manifold 30 is mounted internally within the boundaries of the housing 16 at the first end of the housing to define a manifold chamber 30 therein which is separated from the remaining of the interior of the housing 16 that defines the scrubbing chamber 20 therein. The manifold chamber is mounted against the end wall at the first end of the housing 16 where the gas inlet 22 is located such that the gas inlet passage communicates directly with the interior of the manifold chamber 30. The manifold chamber 30 is also situated adjacent the top end of the housing 16 so as to be located at least partly or fully spaced above the operating level of the scrubbing solution within the scrubbing chamber 20.

A plurality of sparger ducts 32 are mounted within the scrubbing chamber 20 in open communication with the manifold chamber of the manifold 30 such that the gas stream to be scrubbed that is injected into the gas inlet is then further directed through the manifold into the sparger ducts 32. The sparger ducts are elongated in the longitudinal direction of the housing 16 and are mounted to extend generally parallel to one another across a majority (and substantially the full length of) the scrubbing chamber 20 at laterally spaced apart positions relative to one another. Each sparger duct in the illustrated embodiment has a generally rectangular cross-section. When mounted directly adjacent the bottom of the scrubbing chamber, the bottom boundary of each sparger duct 32 can be defined by the floor of the scrubbing chamber corresponding to the bottom wall of the housing 16.

The sparger ducts are greater in height than the prescribed operating level of the scrubbing solution relative to the floor of the scrubbing chamber such that a top end of each sparger duct that spans the full length of the sparger duct between longitudinally opposing ends thereof is spaced above the operating level of the scrubbing solution. In this manner, a head space 34 is defined within each sparger duct that spans the full length of the sparger duct above the operating level of the scrubbing solution such that an open communication path for gas is provided along the length of each sparger duct above the operating level of scrubbing solution and within the boundaries of the sparger duct.

One end of each sparger duct at the first end of the housing 16 includes an inlet opening 36 at the top of the duct which openly connects with the manifold 30 through a bottom boundary of the manifold chamber at a location that is spaced above the operating level of scrubbing solution. In this manner, at start up and before gas within the manifold has been pressurized to an operating pressure, there remains a fully open communication path for the gas above the operating level of scrubbing solution from the gas inlet 22, through the manifold chamber 30, and into the head space 34 of each sparger duct 32 to communicate along the full length of each sparger duct.

Each sparger duct 32 further includes a plurality of discharge openings 38 at evenly spaced positions along the length of each sparger duct 32 adjacent to the bottom end of the duct. In the illustrated embodiment, when the sparger ducts are mounted directly adjacent the bottom boundary of the scrubbing chamber, the discharge openings 38 are located in laterally opposed side walls 39 of each sparger duct along the full length in the longitudinal direction. The discharge openings 38 are thus situated at a location spaced below the operating level of the scrubbing solution in the scrubbing chamber, directly adjacent to the bottom of the ducts 32 and the bottom of the scrubbing chamber 20. The side walls 39 have a height between top and bottom ends of the sparger duct which is at least many times greater (for example 2×, 3×, 4× or 5× greater) than a width of the sparger duct between the side walls of the sparger duct. Each sparger duct is devoid of any other openings other than the discharge openings 38 in the side walls 39 adjacent the bottom of the duct and the inlet opening 36 that only communicates with the manifold 30.

The scrubbing chamber 20 also locates a plurality of baffle arrangements 50 therein in which each baffle arrangement is situated between an adjacent pair of the sparger ducts 32. Accordingly, when there are four sparger ducts spanning the length of the scrubbing chamber, three baffle arrangements are provided nestled between the sparger ducts. Alternatively, when three sparger ducts are present, two baffle arrangements 50 are nestled between the sparger ducts.

Each baffle arrangement 50 includes a divider baffle 52 in the form of a vertical plate or wall which is mounted on the floor of the chamber so as to be centred in the lateral direction between the corresponding pair of sparger ducts 32. The divider baffle 52 is parallel to the ducts while spanning in the longitudinal direction the full length of the ducts, or more particularly the full length of the row of discharge openings 38 in the ducts. The upright plate forming the divider baffle 52 has a height that is approximately one third or less of the height of the sparger ducts. The bottom of the plate is joined to the bottom boundary of the scrubber chamber while the top end of the divider baffle 52 is spaced above the row of discharge openings by a considerable margin such that a majority of the height of the baffle extends above the height of the discharge openings.

Each baffle arrangement 50 further includes a pair of sloped baffles 54 joined to the top edge of the divider baffle 52 along the length of the divider baffle so that the sloped baffles 54 diverge upwardly and laterally away from one another to respective upper edges 56 of the sloped baffles. The sloped baffles 54 are thus arranged in a V-shaped relation along the length of the baffle arrangement while being coupled to the divider baffle so that the overall baffle arrangement has a Y-shape. Each sloped baffle 54 is in an operative relation with a respective row of discharge openings in the side wall of the corresponding adjacent sparger duct 32. More particularly, the sloped baffle 54 is sloped upwardly and towards the side wall of the adjacent sparger duct so that the upper edge 56 is in close proximity to but spaced laterally from the adjacent side wall of the sparger duct at an intermediate location corresponding approximately to half the height of the sparger duct.

The baffle arrangements 50 provide various improvements the function of the scrubber. Firstly, the divider 52 wall separates the flow of gas bubbles exiting the discharge openings from the two adjacent sparger ducts so that the gas bubbles from one of the sparger ducts do not merge with the bubbles from the other sparger duct to result in larger gas bubbles with less fluid contact between the gas and the scrubber solution. Secondly, the sloped baffles 54 redirect the flow of bubbles exiting laterally away from each sparger duct back upwardly and inwardly towards the duct for then rising upwardly alongside the wall of the sparger duct and through the gap between the upper edge 56 of the associated sloped baffle 54 and the sidewall of the duct in a laminar flow that minimizes turbulence in the scrubber solution. Furthermore, the lateral extent of the sloped baffles spanning a majority of the width between the sparger ducts and the full length of the sparger ducts also acts to limit up and down flows in the scrubber solution resulting from intermittent gas discharge from the discharge openings 38. This ensures that the discharge openings in the sparger ducts are always covered by a suitable working height of scrubber solution so that all gas must pass through a sufficient amount of scrubber solution for scrubbing rather than short-circuiting the gas flow from the discharge openings 38 directly to the head space above the scrubber solution.

The gas separator portion 11 of the gas scrubber device 10 includes a separator and collection tank 60 having a cylindrical side wall 62 enclosed by a circular bottom wall 64 and a circular top wall 66. The bottom wall 64 is mounted on a skid bottom 68 to be suitable for transport by winching onto a transport truck and like for example. The top wall 66 receives the scrubber 17 stacked centrally thereon. The interior separating chamber of the collection tank 60 is sealed about the boundary of the tank so that the tank is suitable for containing and collecting liquids at the bottom of the tank as well as being suitable for containing gas therein under pressure above the contained liquids. A manway door 70 is mounted in the side wall 62 to provide access to the interior chamber for maintenance and the like.

A heater compartment 72 having compartment boundary walls is recessed into the collection tank 60 at a second end diametrically opposite from the manway door at the first end. The boundary walls of the heater compartment 72 protrude into the tank while the outer boundary of the heater compartment is enclosed by an access door 74 that opens to the exterior of the tank. In this manner the heater compartment can be accessed from the exterior to insert a heater into the heater compartment. The heater transfers heat through the boundary walls of the heater compartment 72 into the surrounding interior chamber of the collection tank 60. The heater compartment can be left empty when no heater is required.

A flow inlet pipe 76 communicates through the side wall 62 of the collection tank at an intermediate location between the manway door 70 at the first end and the heater compartment 72 with the second end. The flow inlet 76 includes an external flange for connection to various upstream equipment to receive produced hydrocarbon fluids therethrough into the interior of the collection tank. An impact plate 78 is mounted internally within the collection tank in axial alignment with the open end of the flow inlet 76 entering the tank but at a location spaced slightly inwardly into the interior of the tank from the open end of the flow inlet. In this manner, fluids entering the tank through the flow inlet will impact the impact plate 78 so that the momentum of the flow entering the tank is halted and such that the flow is distributed more broadly and transversely to the axial direction of the flow inlet as the fluids enter the tank 60.

The collection tank 60 communicates with the scrubber 17 through a gas passage 80 that communicates through the top wall of the collection tank 60 to the gas inlet pipe 22 of the scrubber chamber. The gas passage 80 openly communicates with each of the interior chamber of the gas separator 11 and the scrubber chamber of the scrubber 17. In this manner, mixed fluids entering the collection tank 60 will impact the plate 78 so that heavier fluids including liquids and suspended solids will fall to the bottom of the collection tank for collection, while the gaseous portion of the incoming fluids will gather at the top of the collection tank 62 then flow through the gas passage 80 into the scrubber chamber 20 of the scrubber 17 as a gas stream driven by the gas pressure of the incoming flow.

The tank further includes a liquid collection pipe 82 in the form of a vertical section of pipe extending through the top wall of the collection tank and down to a bottom end spaced slightly above the bottom wall of the collection tank. The collection pipe 82 is connected in line with an external valve 84 which is operable between open and closed positions. An external flange at the outer end of the collection pipe allows connection of vacuum equipment for cleaning out the liquids collected at the bottom of the collection tank 60. Under normal operation of the gas separator 11, the external valve 84 remains closed; however, when it is desired to discharge collected fluids from the bottom of the collection tank because the fluid level is reaching a maximum operating level of the tank, the external valve 84 can be opened and suction applied to the collection pipe to withdraw the fluids through the liquid collection pipe 82. In some instances, the gas pressure within the collection tank above the collected fluids acts to push the collected liquids through the collection pipe 82 when the external valve 84 is opened.

The device 10 further includes a drain line 86 that is coupled through the end wall of the scrubber 17 opposite from the manifold 30 adjacent to the bottom end of the scrubber housing 16 so that the drain line 86 is in communication with the scrubbing chamber 20 below the operating level of scrubber solution. The drain line 86 has an opposing end in open communication with the interior collection volume of the collection tank 60. A drain valve 88 is coupled in line with the drain line for operation between open and closed positions. Under normal operation of the device 10, the drain valve 88 is closed such that the drain line 86 cannot communicate between the scrubbing chamber 20 and the interior of the collection tank 60. When it is desired to drain spent scrubbing solution 14 from the scrubber 17, the drain valve 88 can be opened to allow gravity drainage of the scrubber solution 14 through the drain line into the collection tank for collection with the separated liquids of the incoming hydrocarbon flow.

In order to overcome back pressure of gas within the collection tank that otherwise may prevent effective drainage of fluid through the drain line, the device 10 further includes a pressure discharge line 90 with a pressure discharge valve 92 mounted in line with the discharge line 90. The pressure discharge line 90 communicates at a first end through the top wall of the collection tank 60 in open communication with the headspace above the maximum liquid collection level of the collection tank 60, and at a second end with the gas outlet pipe 26 of the scrubber 17 prior to the stack pipe 29 mounted thereon. Under normal operation of the device 10, the pressure discharge valve 92 remains closed so that all gas accumulating in the collection tank 60 is directed through the gas passage 80 and into the manifold 30 of the scrubber 17. When it is desired to drain scrubber solution through the drain line, the pressure discharge valve 92 can be momentarily opened so that excess gas pressure within the collection tank 60 is vented through the pressure discharge line 90 and into the gas outlet pipe 26 of the scrubber for discharge through the stack 29 together with the scrubbed gas stream. By removing the excess gas pressure within the collection tank 60, the scrubber solution is free to flow through the drain line by gravity.

Prior to use of the device 10 for scrubbing a gas stream, the scrubbing chamber is filled with the scrubbing solution 14 at the prescribed operating level 40. A flow of produced hydrocarbon fluids is then directed into the flow inlet 76 of the gas separator 11 so that liquids and suspended solids collect within the bottom of the collection tank while the separated gas stream exits through the gas passage 80 into the gas inlet pipe 22 of the scrubbing chamber. The manifold chamber 30 which receives the gas stream from the separator 11 then further directs the gas stream along the length of each sparger duct 32 within the head space 34 thereof. As the manifold chamber 30 is pressurized with the incoming gas stream, pressure builds up in the head space 34 evenly along the length of each sparger duct to push any fluid accumulated in the bottom portion of each sparger duct downwardly through the discharge openings 38. Continued injection of the gas stream under pressure forces the gas out of the discharge openings 38 to be bubbled upwardly through the scrubbing solution that surrounds the lower portion of each sparger duct 32 within the scrubbing chamber. The gas stream is scrubbed as it passes through the scrubbing solution 20 prior to reaching the upper portion of the scrubbing chamber 20 above the prescribed operating level 40. The scrubbed gas within the upper portion of the scrubbing chamber 20 can then freely exit the scrubbing chamber through the gas outlet 26 to downstream equipment such as the exhaust stack 29.

By locating the manifold chamber above the sparger duct, the manifold remains above the fluid level so that the scrubbing solution does not have to be displaced out of the entire manifold in order to push the gas into the sparger ducts. This eliminates nearly all the back pressure to the pump as well as the back pressure to the pressure relief valve of the pumping system. Having air space above the fluid level throughout the entire manifold system and sparger ducts allows the manifold chamber to communicate with the sparger ducts at any location along the length of the sparger ducts, including being located at one end of the sparger ducts according to the illustrated embodiment, while still maintaining a completely even gas distribution to the discharge openings 38 along the length of each sparger duct due to the pressure balancing within the head space 34 of each sparger duct. The even distribution of gas to the discharge openings keeps the gas bubbles discharged into the scrubbing solution much smaller and therefore better able to mix and chemically react with the scrubbing solution for a more complete scrubbing of the gas stream. The number of sparger ducts can be varied and increased as desired due to the uniform pressure above the fluid level in the manifold system connected to the head space within each sparger duct.

Since various modifications can be made in the invention as herein above described, and many apparently widely different embodiments of same made, it is intended that all matter contained in the accompanying specification shall be interpreted as illustrative only and not in a limiting sense.

1. A gas scrubber device for scrubbing a waste gas from a gas stream using a scrubbing solution, the device comprising:
a scrubbing chamber arranged to contain an operating level of the scrubbing solution therein;
a manifold having a gas inlet arranged to receive the gas stream into the manifold;
at least one sparger duct supported within the scrubbing chamber to extend longitudinally between two opposing ends of the sparger duct, in which the at least one sparger duct is in communication with the manifold to receive the gas stream from the manifold, and in which the sparger duct includes a plurality of discharge openings formed therein below the operating level of the scrubbing solution so as to be arranged to discharge the gas stream into the scrubbing solution in the scrubbing chamber; and
a discharge passage in communication with the scrubbing chamber above the operating level of the scrubbing solution so as to be arranged to discharge the gas stream from the scrubbing chamber subsequent to the gas stream passing through the scrubbing solution;
wherein the at least one sparger duct is supported within the scrubbing chamber so as to be only partially submerged relative to the operating level of the scrubbing solution whereby a head space is defined within the sparger duct above the operating level of the scrubbing solution, the head space extending in open communication between the ends of the sparger duct.

2. The device according to claim 1 wherein the scrubbing chamber is elongated in a longitudinal direction extending between the ends of the scrubbing chamber and wherein said at least one sparger duct extends from the manifold in said longitudinal direction of the tank.

3. The device according to claim 1 wherein said at least one sparger duct comprises a plurality of sparger ducts extending longitudinally between the ends of the duct.

4. The device according to claim 3 wherein the sparger ducts are parallel and laterally spaced apart from one another.

5. The device according to claim 1 wherein the manifold is supported at one end of the scrubbing chamber above the operating level of the scrubbing solution and wherein said at least one sparger duct spans a majority of a length of the scrubbing chamber from the manifold at the end of the scrubbing chamber.

6. The device according to claim 1 wherein said at least one sparger duct locates the discharge openings primarily in laterally opposing side walls of the sparger duct in which the side walls have a height between top and bottom ends of the sparger duct which is at least two times greater than a width of the sparger duct between the side walls of the sparger duct.

7. The device according to claim 1 wherein said at least one sparger duct communicates with the manifold at a location spaced above the operating level of the scrubbing solution.

8. The device according to claim 1 wherein said at least one sparger duct communicates with the manifold at a top end of the sparger duct.

9. The device according to claim 1 wherein the discharge openings in the sparger duct are situated adjacent a bottom of the sparger duct.

10. The device according to claim 1 wherein said at least one sparger duct is directly adjacent a bottom of the sparger duct.

11. The device according to claim 1 wherein the manifold is above the operative level of the scrubbing solution.

12. The device according to claim 1 further comprising at least one baffle supported in the scrubbing chamber alongside said at least one sparger duct so as to be arranged to limit turbulent flow of the scrubbing solution in response to the discharge of the gas stream into the scrubbing solution in the scrubbing chamber.

13. The device according to claim 12 wherein said at least one sparger duct comprises a plurality of sparger ducts extending longitudinally between the ends of the duct so as to be spaced apart laterally from one another, and wherein said at least one baffle includes an upright divider baffle supported at an intermediate location between an adjacent pair of the sparger ducts.

14. The device according to claim 12 wherein said at least one sparger duct comprises a plurality of sparger ducts extending longitudinally between the ends of the duct so as to be spaced apart laterally from one another, and wherein said at least one baffle includes a plurality of sloped baffles, each sloped baffle being in operative relation with the discharge openings along one side of a respective one of the sparger ducts and being sloped upwardly and inwardly towards the respective sparger duct to terminate at an upper edge of the sloped baffle that is spaced above the discharge openings and spaced outward from the side of the respective sparger duct.

15. The device according to claim 12 wherein said at least one sparger duct comprises a plurality of sparger ducts extending longitudinally between the ends of the duct so as to be spaced apart laterally from one another, and wherein said at least one baffle includes a baffle arrangement between each adjacent pair of the sparger ducts, the baffle arrangement including:
(i) an upright divider baffle supported at an intermediate location between the adjacent pair of the sparger ducts; and
(ii) a pair of sloped baffles extending upwardly from the upright divider baffle in diverging relation to one another to terminate at respective upper edges in proximity to respective sparger ducts of the adjacent pair of sparger ducts respectively such that each upper edge is in operative relation with the discharge openings of the respective sparger duct and such that each upper edge is spaced above the discharge openings and spaced outward from the side of the respective sparger duct.

16. The device according to claim 1 further comprising a gas separator for separating produced hydrocarbon fluids into collected liquids and said gas stream directed into the gas inlet of the manifold, the gas separator comprising:
a liquid collection tank arranged to collect a maximum level of the collected liquids therein;
a flow inlet coupled to the liquid collection tank at a level above the maximum level so as to be arranged to receive the produced hydrocarbon fluids into the liquid collection tank through the flow inlet for separation of the gas stream from the collected liquids in the liquid collection tank;
a gas passage coupled between (i) the liquid collection tank above the maximum level and (ii) the gas inlet of the manifold so as to be arranged to direct the gas stream from the gas separator to the gas inlet of the manifold; and
a drain line connected between the scrubbing chamber below the operating level of the scrubbing solution and the liquid collection tank, the drain line including a valve connected in line with the drain line to selectively open and close the drain line.

17. The device according to claim 16 further comprising a pressure discharge valve in operative connection with the liquid collection tank at a location above the maximum level so as to be arranged to controllably discharge pressure of the gas stream from the liquid collection tank when the pressure discharge valve is opened.

18. The device according to claim 17 wherein the pressure discharge valve is in communication with the discharge passage of the scrubbing chamber such that the gas stream in the liquid collection tank is discharged to the discharge passage of the scrubbing chamber when the pressure discharge valve is opened.

19. A method of operating the device according to claim 1 comprising:
(i) providing the scrubbing solution in the scrubbing chamber at said operating level such that (a) said head space is defined within said at least one sparger duct above the operating level of the scrubbing solution, and (b) the discharge openings in said at least one sparger duct are spaced below the operating level; and
(ii) injecting the gas stream into the manifold such that the gas stream passes through the head space to the discharge openings in said at least one sparger for discharge through the discharge passage of the scrubbing chamber after the gas stream passes through the scrubbing solution.

20. A gas scrubber device for separating produced hydrocarbon fluids into collected liquids and a gas stream, and for scrubbing a waste gas from the gas stream using a scrubbing solution, the device comprising:
a scrubbing chamber arranged to contain an operating level of the scrubbing solution therein;
a manifold having a gas inlet arranged to receive the gas stream into the manifold;
at least one sparger duct supported within the scrubbing chamber in communication with the manifold to receive the gas stream from the manifold, in which the sparger duct includes a plurality of discharge openings formed therein below the operating level of the scrubbing solution so as to be arranged to discharge the gas stream into the scrubbing solution in the scrubbing chamber;
a discharge passage in communication with the scrubbing chamber above the operating level of the scrubbing solution so as to be arranged to discharge the gas stream from the scrubbing chamber subsequent to the gas stream passing through the scrubbing solution;
a liquid collection tank arranged to collect a maximum level of the collected liquids therein;
a flow inlet coupled to the liquid collection tank at a level above the maximum level so as to be arranged to receive the produced hydrocarbon fluids into the liquid collection tank through the flow inlet for separation of the gas stream from the collected liquids in the liquid collection tank;
a gas passage coupled between (i) the liquid collection tank above the maximum level and (ii) the gas inlet of the manifold so as to be arranged to direct the gas stream from the gas separator to the gas inlet of the manifold; and
a drain line connected between the scrubbing chamber below the operating level of the scrubbing solution and the liquid collection tank, the drain line including a valve connected in line with the drain line to selectively open and close the drain line.
